(19) United States
(12) Patent Application Publication
(10) Pub. No.: US 2004/0087754 A1
(43) Pub. Date: May 6, 2004

(54) Polyurethane compounds and articles prepared therefrom

(76) Inventors: Paul Foley, Midland, MI (US); John N. Argyropoulos, Scott Depot, WV (US); David R. Bryant, South Charleston, WV (US); Debkumar Bhattacharjee, Lake Jakson, TX (US); Aisa Sendijarevic, Troy, MI (US)

Correspondence Address: UNION CARBIDE CHEMICALS AND PLASTICDS TECHNOLOGY, CORPORATION, P.O. BOX 1967, MIDLAND, MI, 48674, US

(21) Appl. No.: 10/284,993

(22) Filed: Oct. 31, 2002

(51) Int. Cl. C08G 18/00; C08G 18/10

(52) U.S. Cl. 528/59; 528/65; 528/66

(57) ABSTRACT

This invention relates to polyurethane compounds, e.g., elastomers, which are the reaction product of a cycloaliphatic diisocyanate, a polyol and a chain extender. The cycloaliphatic diisocyanate comprises (i) trans-1,4-bis(isocyanatomethyl)cyclohexane or (ii) an isomeric mixture of two or more of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, provided the isomeric mixture comprises at least about 5 weight percent of said trans-1,4-bis(isocyanatomethyl)cyclohexane. This invention also relates to shaped and molded articles prepared from said polyurethane compounds.

### BRIEF SUMMARY OF THE INVENTION

1. Technical Field

This invention relates to polyurethane compounds, e.g., elastomers, based on certain cycloaliphatic diisocyanates, e.g., 1,3-and 1,4-bis(isocyanatomethyl)cyclohexane, that have been copolymerized with one or more oligomeric polyols and one or more short chain glycols and/or amines, and to shaped and molded articles prepared from said polyurethane compounds.

2. Background of the Invention

Polyurethane elastomers are well known articles of commerce that are characterized by good abrasion resistance, toughness, strength, extensibility, low temperature flexibility, chemical and oil resistance, and other chemical and physical properties. The level of each of these mechanical and chemical factors is dependent on the inherent properties of the component or building block materials making up any particular polyurethane.

The components used to form polyurethane compounds comprise three basic building blocks: polyols, polyisocyanates and chain extenders. It is through selection and ratios of these building blocks coupled with preparation process and type of polyurethane desired that a myriad of polyurethanes with a wide variety of properties can be made. Types of polyurethane elastomers include thermoplastics, thermosets, millable gums, liquid castables, and microcellular elastomers.

In certain applications where a polyurethane product, particularly an elastomer, is used for a coating or outer surface of a product, it may be desirable for this polyurethane layer to remain transparent. Based on the chemical characteristics of polyisocyanates, there are few commercially available aliphatic polyisocyanates that yield good quality polyurethanes with non-yellowing and good weatherability properties when combined with commercially available polyols and chain extenders.

Therefore there remains a need for polyurethanes with improved mechanical and/or chemical characteristics and/or for polyurethanes that are manufactured with polyisocyanates that have lower volatility and/or an increased ratio of isocyanate functionality to polyisocyanate molecular weight. Highly desirable polyurethanes would be those based on components that yield polymers having good mechanical and chemical characteristics, non-yellowing characteristics, good resistance to sunlight, good weatherability, transparency and that can achieve these properties in an environmentally friendly and cost-effective manner.

### DISCLOSURE OF THE INVENTION

It has been found that polyurethane compounds prepared from a cycloaliphatic diisocyanate, i.e., trans-1,4-bis(isocyanatomethyl)cyclohexane or an isomeric mixture of two or more of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, provided the isomeric mixture comprises at least about 5 weight percent of said trans-1,4-bis(isocyanatomethyl)cyclohexane, that has been reacted with a polyester, polylactone, polyether, polyolefin or polycarbonate polyol and saturated or unsaturated, linear or branched chain extenders in various ratios of these components or building blocks, have excellent strength characteristics, high temperature resistance, good low temperature flexibility, excellent weathering characteristics including sunlight resistance and non-yellowing properties in comparison to polyurethanes prepared from the same polyols and chain extenders that have been reacted with known, commercial polyisocyanates. This invention also encompasses shaped and molded articles prepared from the novel polyurethanes of the invention.

This invention relates to a polyurethane comprising the reaction product of a cycloaliphatic diisocyanate, a polyol and a chain extender, wherein said cycloaliphatic diisocyanate comprises (i) trans-1,4-bis(isocyanatomethyl)cyclohexane or (ii) an isomeric mixture of two or more of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, with the proviso said isomeric mixture comprises at least about 5 weight percent of said trans-1,4-bis(isocyanatomethyl)cyclohexane.

This invention also relates to a polyurethane precursor composition comprising a cycloaliphatic diisocyanate, a polyol and a chain extender, wherein said cycloaliphatic diisocyanate comprises (i) trans-1,4-bis(isocyanatomethyl)cyclohexane or (ii) an isomeric mixture of two or more of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, with the proviso said isomeric mixture comprises at least about 5 weight percent of said trans-1,4-bis(isocyanatomethyl)cyclohexane.

This invention further relates to a composition comprising an isomeric mixture of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, wherein said isomeric mixture comprises at least about 5 weight percent of said trans-1,4-bis(isocyanatomethyl)cyclohexane.

This invention yet further relates to a composition comprising an isomeric mixture of cis-1,3-cyclohexane-bis(aminomethyl), trans-1,3-cyclohexane-bis(aminomethyl), cis-1,4-cyclohexane-bis(aminomethyl) and trans-1,4-cyclohexane-bis(aminomethyl), wherein said isomeric mixture comprises at least about 5 weight percent of said trans-1,4-cyclohexane-bis(aminomethyl).

### DETAILED DESCRIPTION

The polyurethanes of this invention can be thermoplastic or thermoset and can be made cross linkable through unsaturation introduced in the chain extender or polyol or by variation of ingredient ratios such that residual functionality remains after polyurethane preparation (as in millable gums). The polyurethanes can be prepared by mixing all ingredients at essentially the same time in a “one-shot” process, or can be prepared by step-wise addition of the ingredients in a “prepolymer process” with the processes being carried out in the presence of or without the addition of optional ingredients as described herein. The polyurethane forming reaction can take place in bulk or in solution with or without the addition of a suitable catalyst that would promote the reaction of isocyanates with hydroxyl or other functionality. Polyurethanes of this invention can be made that are soft and with high elongation, are hard with low elongation, are weatherable, are color stable and non-yellowing, and the like.

The polyurethane elastomers of this invention may be considered to be block or segmented copolymers of the (AB)ₙ type that contain soft segments, the A portion of the molecule, and hard segments, the B portion of the molecule as described in J. Applied Polymer Sci., 19, 2503-2513 (1975). The weight percent hard segment is the weight ratio of the number of grams of polyisocyanate required to react with a chain extender plus the grams of the chain extender divided by the total weight of the polyurethane.

The cycloaliphatic diisocyanates useful in this invention comprise (i) trans-1,4-bis(isocyanatomethyl)cyclohexane or (ii) an isomeric mixture of two or more of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, with the proviso said isomeric mixture comprises at least about 5 weight percent of said trans-1,4-bis(isocyanatomethyl)cyclohexane. When a mixture is used, preferably the 1,4-isomer comprises at least 10% of the mixture. For the production of elastomer, when a mixture is used, preferably the 1,4-isomer comprises at least 20% percent of the mixture. The preferred cycloaliphatic diisocyanates are represented by the following structural Formulas I through IV:

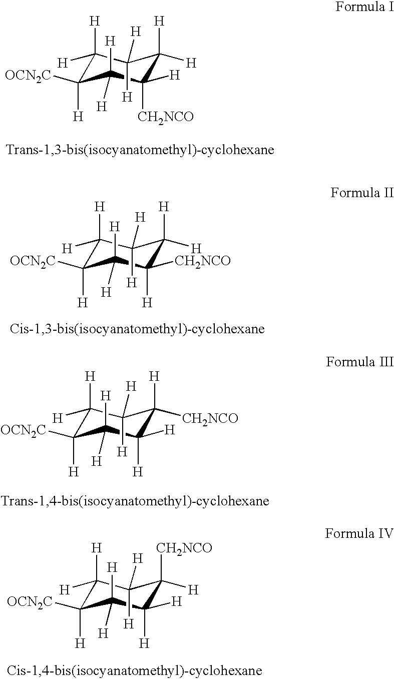

These cycloaliphatic diisocyanates may be used in admixture as manufactured from, for example, the Diels-Alder reaction of butadiene and acrylonitrile, subsequent hydroformylation, then reductive amination to form the amine, i.e., cis-1,3-cyclohexane-bis(aminomethyl), trans-1,3-cyclohexane-bis(aminomethyl), cis-1,4-cyclohexane-bis(aminomethyl) and trans-1,4-cyclohexanebis(aminomethyl), followed by reaction with phosgene to form the cycloaliphatic diisocyanate mixture. The preparation of the cyclohexane-bis(aminomethyl) is described in U.S. Pat. No. 6,252,121, the disclosure of which is incorporated herein by reference. The polyurethane compositions of this invention contain from about 10 to 50 weight percent, preferably from about 15 to 40 weight percent, more preferably from 15 to 35, of the isocyanate.

Polyols useful in the present invention are compounds which contain two or more isocyanate reactive groups. Representative of suitable polyols are geerally known and are desribed in such publications as High Polymers, Vol. XVI; “Polyurethanes, Chemistry and Technology”, by Saunders and Frisch, Interscience Publishers, New York, Vol. 1, pp. 32-42, 44-54 (1962) and Vol II. Pp. 5-6, 198-199 (1964); Organic Polymer Chemistry by K. J. Saunders, Chapman and Hall, London, pp. 323-325 (1973); and Developments in Polyurethanes, Vol. I, J. M. Burst, ed., Applied Science Publishers, pp. 1-76 (1978). Representative of suitable polyols include polyester, polylactone, polyether, polyolefin, polycarbonate polyols, and various other polyols.

Illustrative of the polyester polyols are the poly(alkylene alkanedioate) glycols that are prepared via a conventional esterification process using a molar excess of an aliphatic glycol with relation to an alkanedioic acid. Illustrative of the glycols that can be employed to prepare the polyesters are ethylene glycol, diethylene glycol, propylene glycol, dipropylene glycol, 1,3-propanediol, 1,4-butanediol and other butanediols, 1,5-pentanediol and other pentane diols, hexanediols, decanediols, dodecanediols and the like. Preferably the aliphatic glycol contains from 2 to about 8 carbon atoms. Illustrative of the dioic acids that may be used to prepare the polyesters are maleic acid, malonic acid, succinic acid, glutaric acid, adipic acid, 2-methyl-1,6-hexanoic acid, pimelic acid, suberic acid, dodecanedioic acids, and the like. Preferably the alkanedioic acids contain from 4 to 12 carbon atoms. Illustrative of the polyester polyols are poly(hexanediol adipate), poly(butylene glycol adipate), poly(ethylene glycol adipate), poly(diethylene glycol adipate), poly(hexanediol oxalate), poly(ethylene glycol sebecate), and the like.

Polylactone polyols useful in the practice of this invention are the di-or tri- or tetra-hydroxyl in nature. Such polyol are prepared by the reaction of a lactone monomer; illustrative of which is δ-valerolactone, ε-caprolactone, ε-methyl-ε-caprolactone, ξ-enantholactone, and the like; is reacted with an initiator that has active hydrogen-containing groups; illustrative of which is ethylene glycol, diethylene glycol, propanediols, 1,4-butanediol, 1,6-hexanediol, trimethylolpropane, and the like. The production of such polyols is known in the art, see, for example, U.S. Pat. Nos. 3,169,945, 3,248,417, 3,021,309 to 3,021,317. The preferred lactone polyols are the di-, tri-, and tetra-hydroxyl functional ε-caprolactone polyols known as polycaprolactone polyols.

The polyether polyols include those obtained by the alkoxylation of suitable starting molecules with an alkylene oxide, such as ethylene, propylene, butylene oxide, or a mixture thereof. Examples of initiator molecules include water, ammonia, aniline or polyhydric alcohols such as dihyric alcohols having a molecular weight of 62-399, especially the alkane polyols such as ethylene glycol, propylene glycol, hexamethylene diol, glyerol, trimethylol propane or trimethylol ethane, or the low molecular weight alcohols containing ether groups such as diethylene glycol, triethylene glycol, dipropylene glyol or tripropylene glycol. Other commonly used initiators include pentaerythritol, xylitol, arabitol, sorbitol mannitol and the like. For producing elastomers, a poly(propylene oxide) polyols include poly(oxypropylene-oxyethylene) polyols is used. Preferably the oxyethylene content should comprise less than about 40 weight percent of the total and preferably less than about 25 weight percent of the total weight of the polyol. The ethylene oxide can be incorporated in any manner along the polymer chain, which stated another way means that the ethylene oxide can be incorporated either in internal blocks, as terminal blocks, may be randomly distributed along the polymer chain, or may be randomly distributed in a terminal oxyethylene-oxypropylene block. These polyols are conventional materials prepared by conventional methods.

Other polyether polyols include the poly(tetramethylene oxide) polyols, also known as poly(oxytetramethylene)glycol, that are commercially available as diols. These polyols are prepared from the cationic ring-opening of tetrahydrofuran and termination with water as described in Dreyfuss, P. and M. P. Dreyfuss, Adv. Chem. Series, 91, 335 (1969).

Polycarbonate containing hydroxy groups include those kown per se such as the products obtained from the reaction of diols such as propanediol-(1,3), butanediols-(1,4) and/or hexanediol-(1,6), diethylene glycol, triethylene glycol or tetraethylene glycol with diarylcarbonates, e.g. diphenylcarbonate or phosgene.

Illustrative of the various other polyols suitable for use in this invention are the styrene/allyl alcohol copolymers; alkoxylated adducts of dimethylol dicyclopentadiene; vinyl chloride/vinyl acetate/vinyl alcohol copolymers; vinyl chloride/vinyl acetate/hydroxypropyl acrylate copolymers, copolymers of 2-hydroxyethylacrylate, ethyl acrylate, and/or butyl acrylate or 2-ethylhexyl acrylate; copolymers of hydroxypropyl acrylate, ethyl acrylate, and/or butyl acrylate or 2-ethylhexylacrylate, and the like.

Other polyols which can be used include hydrogenated polyisoprene or polybutadiene having at least two hydroxyl groups in the molecule and number-average molecular weight of 1,000-5,000. Non-hydrogenated polybutadiene polyols, such as described in U.S. Pat. No. 5,865,001 may also be used.

Generally for use in the present invention, the hydroxyl terminated polyol has a number average molecular weight of 200 to 10,000. Preferably the polyol has a molecular weight of from 300 to 7,500. More preferably the polyol has a number average molecular weight of from 400 to 6,000. Based on the initiator for producing the polyol, the polyol will have a functionality of from 1.5 to 8. Preferably the polyol has a functionality of 2 to 4. For the production of elastomers based on the dispersions of the present invention, it is preferred that a polyol or blend of polyols is used such that the nominal functionality of the polyol or blend is equal or less than 3.

The chain extenders that may be used in this invention are characterized by two or more, preferably two, functional groups each of which contains “active hydrogen atoms.” These functional groups are preferably in the form of hydroxyl, primary amino, secondary amino, and mixtures thereof. The term “active hydrogen atoms” refers to hydrogen atoms that because of their placement in a molecule display activity according to the Zerewitinoff test as described by Kohler in J. Am. Chemical Soc., 49, 31-81 (1927). The chain extenders may be aliphatic, cycloaliphatic, or aromatic and are exemplified by diols, triols, tetraols, diamines, triamines, aminoalcohols, and the like. Illustrative of the difunctional chain extenders are ethylene glycol, diethylene glycol, propylene glycol, dipropylene glycol, 1,3-propanediol, 1,3-butanediol, 1,4-butanediol, 1,5-pentanediol and other pentane diols, 1,6-hexanediol and other hexanediols, decanediols, dodecanediols, bisphenol A, hydrogenated bisphenol A, 1,4-cyclohexanediol, 1,4-bis(2-hydroxyethoxy)cyclohexane, 1,4-bis(2-hydroxyethoxy)benzene, Esterdiol 204, N-methylethanolamine, N-methyliso-propylamine, 4-aminocyclohexanol, 1,2-diaminotheane, 1,3-diaminopropane, diethylenetriamine, toluene-2,4-diamine, toluene-1,6-diamine, and the like. Aliphatic compounds containing from 2 to about 8 carbon atoms are preferred. If thermoplastic or soluble polyurethanes are to be made, the chain extenders will be difunctional in nature. Illustrative of useful amine chain extenders are ethylenediamine, monomethanolamine, propylenediamine, and the like. If thermoset or insoluble polyurethanes are to be made, the chain extenders may be difunctional or higher multifunctional in nature. Illustrative of the higher functional chain extenders, which are usually used in small amounts of 1 to 20 weight percent of the total chain extender, are glycerol, 1,1,1-trimethylolethane, 1,1,1-trimethylolpropane, pentaerythritol, 1,3,6-hexanetriol, and the like.

Preferred chain extenders are the polyolamines due to their faster reaction with the isocyanate in the aqueous phase. It is particularly preferred that the chain extender be selected from the group consisting of amine terminated polyethers such as, for example, JEFFAMINE D-400 from Huntsman Chemical Company, amino ethyl piperazine, 2-methyl piperazine, 1,5-diamino-3-methyl-pentane, isophorone diamine, bis(aminomethyl)cyclohexane and isomers thereof, ethylene diamine, diethylene triamine, aminoethyl ethanolamine, triethylene tetraamine, triethylene pentaamine, ethanol amine, lysine in any of its stereoisomeric forms and salts thereof, hexane diamine, hydrazine and piperazine.

Other chain extenders include phenylene or methylene diamine (MDA), primary or secondary diamines. These can be generally represented by

R¹HN—Ar—NHR¹

and

R¹HN—Ar—CH₂—Ar—NHR¹

where Ar represents the aromatic ring and each R¹ is independently an alkyl group containing from 1 to 20 carbon atoms. Preferably the alkyl groups contain 1 to 10 carbon atoms. More preferably the alkyl groups contain 4 to 8 carbon atoms. Commercially available products include UNILINK™ diamines available from UOP. Other useful chain extenders include halogen or alkyl substituted derivatives of methylene dianiline or phenylene diamine and blocked MDA or phenylene diamine. Examples include methylene bis(orthochloroaniline) (MOCA) and methylene bis(di-t-butylaniline). Examples of blocked amines include CAYTUR™ blocked curatives available from Uniroyal.

The polyurethane compositions of this invention contain from about 2 to 25 weight percent, preferably from about 3 to 20 weight percent, more preferably 4 to 18 of the chain extender component.

If desired, optionally small amounts of monohydroxyl- or monoamino-functional compounds, often termed “chain stoppers,” may be used to control molecular weight. Illustrative of such chain stoppers are the propanols, butanols, pentanols, hexanols, and the like. When used, chain stoppers are used in minor amounts of from about 0.1% by weight to about 2% by weight of the entire reaction mixture leading to the polyurethane composition.

It is well known to those skilled in the art of polyurethane preparation that thermoplastic or soluble and moldable polyurethanes will result if all difunctional compounds, i.e., difunctional polyols, difunctional isocyanates, and difunctional chain extenders, are used to prepare said polyurethane. It is also well known to those skilled in the art of polyurethane preparation that thermoset or insoluble and intractable polyurethanes will result if any one or more of polyols, isocyanates, and chain extenders have a functionality of greater than two are employed alone or in combination with difunctional polyols, isocyanates, or chain extenders.

The polyurethane prepolymer compositions of this invention contain from about 1 to 20 weight percent unreacted NCO, preferably from about 2 to 15 weight percent NCO, more preferably from 2 to 10 weight percent NCO.

The character of the polyurethane compositions of this invention will be influenced to a significant degree by the overall molar ratio of the sum of the mixture comprising polyols plus chain extenders to the bis(isocyanatomethyl)cyclohexane compounds and, in general, such ratio will be between about 0.95 and about 1.1. This molar ratio of reactants is for all practical purposes, essentially the same result that can be obtained by referring to the ratio of isocyanate reactive equivalents or hydroxyl groups to isocyanate equivalents or isocyanate groups in the reaction mixture. The reciprocal of these ratios, i.e. the ratio of isocyanate equivalents to the equivalents of the active hydrogen moieties is known as the “isocyanate index.”

Optionally, minor amounts of other multifunctional isocyanates can be used in the reaction mixture. Illustrative of such isocyanates are 2,4- and 2,6-toluene diisocyanates, 4.4′-biphenylene diisocyanate, 4,4′-diphenylmethane diisocyanate, meta- and paraphenylene diisocyanates, 1,5-naphthylene diisocyanate, 1,6-hexamethylene diisocyanate, bis(2-isocyanato)fumarate, 4,4′-dicyclohexanemethyl diisocyanate, 1,5-tetrahydronaphthylene diisocyanate, isophorone diisocyanate, 4,4′-methylene bis(cyclohexyl)isocyanate, and the like. The minor amounts of other multifunctional isocyanates can range from about 0.1% to about 20% or more, preferably from about 0% to 10%, of the total polyfunctional isocyanate used in the formulation.

Optionally, catalysts that will promote or facilitate the formation of urethane groups can be used in the formulation. Illustrative of useful catalysts are stannous octanoate, dibutyltin dilaurate, stannous oleate, tetrabutyltin titanate, tributyltin chloride, cobalt naphthenate, dibutyltin oxide, potassium oxide, stannic chloride, N,N,N,N′-tetramethyl-1,3-butanediamine, bis [2-(N,N-dimethylamino)ethyl] ether, 1,4-diazabicyclo[2.2.2]octane; zirconium chelates, aluminum chelates and bismuth carbonates as described in Paint & Coatings Industry, Metal Catalyzed Urethane Systems, XVI, No. 10, 80-94 (October 2000), and the like. If microcellular products are to be prepared, it is advantageous to employ a combination of a tertiary amine compound and an organic tin compound as the catalyst for the formulation of reactants. The catalysts, when used, are employed in catalytic amounts that may range from about 0.001% and lower to about 2% and higher based on the total mount of polyurethane-forming ingredients.

The polyurethane compositions of this invention may be thermoplastic or thermoset in character and these can be prepared according to several different procedures. The thermoplastic polyurethane compositions of the invention can be prepared when the overall molar ratio of the reactants is such that the sum of the difunctional polyol plus difunctional chain extender to the bis(isocyanatomethyl)cyclohexane compounds is essentially one. This is the same as saying the ratio of the sum of total active hydrogen equivalents in the form of hydroxyl with and/or without amino or other active hydrogen-containing groups to the total number of isocyanato equivalents is essentially one. The reaction for preparation of the polyurethanes of the invention can be conducted in bulk or in a suitable solvent, illustrative of which is dimethylformamide, cyclohexanone, and the like, generally at an elevated temperature of about 70° C. to about 160° C. for a period of time ranging from minutes to several hours. After analysis to ensure that effectively all isocyanato group are reacted, the polyurethane can be cooled, diced, powdered, precipitated and dried, if made in solvent, stored, and later processed into useful articles. Optional ingredients such as a catalyst, colorant, or the like may be added. If desired, solutions of the polyurethanes may be spun into elastomeric fibers by a wet spinning process such as that used to make Spandex fibers.

Various processes can be used to prepare the thermoplastic polyurethanes of the invention. Among these processes is the so called “one-shot” process in which the mixture comprising polyols, organic diisocyanate, chain extenders, and other ingredients, if any, are simultaneously mixed and reacted at an elevated temperature as, for example, briefly described in J. Applied Polymer Sci., 19, 2491 (1975). Preferably, the difunctional polyol and difunctional chain extender are mixed. Then this mixture and the bis(isocyanatomethyl)cyclohexane compounds are heated separately to about 70° C. to about 165° C. Then the polyol/chain extender mixture is added to the bis(isocyanatomethyl)cyclohexane compounds under rapid mixing conditions. Alternatively, the heated isocyanate can be added to the polyol/chain extender mixture with rapid agitation. After well mixing, the reaction mixture is allowed to react under suitable heating conditions so the temperature is maintained at about 70° C. to 165° C. until the viscous mixture begins to solidify for a time period that is usually from two minutes to ten minutes or more. The reaction mass is now a partially cured product that can be easily removed and reduced into a diced or pelletized form. The product can be thermoplastically processed and is suitable for fabrication into finished objects by techniques such as compression molding, extrusion, injection molding, and the like, as is well known to those skilled in the art of polyurethane manufacture.

Another typical process for preparing the thermoplastic polyurethanes of the invention involves the so called “prepolymer” method in which the polyol is reacted with a sufficient quantity of bis(isocyanatomethyl)cyclohexane compounds so that an isocyanato-terminated prepolymer, illustrative of which is the average structure as shown in Formula V, is obtained.

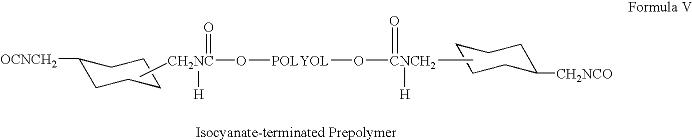

The isocyanato-terminated prepolymer is then reacted with the difunctional chain extender at the temperatures and times used for the “one-shot” thermoplastic polyurethane, recovered, and stored for future use. The prepolymer may be used immediately or it may be stored for future reaction with the chain extender. Variations of this prepolymer technique can be employed, illustrative of which the difunctional chain extender is first reacted with the diisocyanate to form the prepolymer and then subsequently with the polyol. Hydroxyl-terminated prepolymers can be formed by reacting one mole of the bis(isocyanatomethyl)cyclohexane compounds is reacted with two moles of the polyol, with two moles of the polyol mixed with the chain extender, or with two moles of the chain extender and then reacting the remainder of the isocyanate and any polyol or chain extender in a subsequent reaction.

Thermoplastic millable gums can be prepared when the overall ratio of the reactants is such that the sum of the polyol plus the chain extender to the bis(isocyanatomethyl)cyclohexane compounds is from about 1.0 to about 1.1. The millable gums can be prepared by either a “one-shot” process or a “prepolymer” process wherein the reaction time can vary from minutes to hours at temperatures of from about 50° C. to 165° C. The resulting polyurethane millable product or gum can be thoroughly mixed with additional bis(isocyanatomethyl)cyclohexane compounds or other multifunctional polyisocyanates on a rubber mill and then cured in a mold under heat and appropriate pressure. The additional polyisocyanate reacts with any residual active hydrogen atoms that are present in the form of hydroxyl and/or amino groups. This reaction is thought to effect branching and cross linking by reacting with the hydrogen of urethane groups and/or urea groups, if any, to thus form allophanate and/or biuret linkages. The millable gums may also be cured with peroxides, illustrative of which are dicumyl peroxide, benzoyl peroxide and the like. In this case, hydrogen atoms are extracted from the polyol or chain extender to form a free radical. Free radicals from various chains combine to form stable crosslinks. If unsaturation is introduced by means of the polyol or chain extender, it is possible to crosslink the gums with sulfur in a vulcanization reaction.

Another useful type polyurethane product envisioned in this invention is microcellular elastomeric polyurethane products and foams that have a density from about 15 to about 60, preferably from about 20 to about 55, pounds per cubic foot. Microcellular polyurethanes are high density, 15 to about 60-pounds/cubic foot, closed cell, high performance polyurethane foams with an integral skin of desired thickness. Such microcellular products are recognized as important commercial engineering materials that have the desirable properties of non-cellular elastomers but are lower in cost per molded item because of their lower density. Microcellular polyurethanes are used for automobile bumpers and fascia, shoe soles, industrial tires, industrial rollers, and numerous other industrial applications.

The microcellular polyurethane products of this invention are prepared by processing two reactive liquid streams in a urethane metering-mixing machine. One of the liquid streams contains the bis(isocyanatomethyl)cyclohexane compounds and optionally a blowing agent such as a halocarbon or similarly volatile, nonreactive compound. The other liquid stream usually contains the polyol, chain extender, catalyst, and water, if the latter is used. Usually the ratio of active hydrogen atom equivalents to the bis(isocyanatomethyl)cyclohexane compound equivalents is about one, that is total active hydrogen equivalents of from about 0.95 to about 1.05 for each isocyanate equivalent. Blowing agents are compounds that are inert and do not deleteriously interfere with the urethane reaction process and that will volatilize at or below the reaction temperatures involved and cause the gelling reaction mass to foam. Desirable blowing agents are water, halogenated hydrocarbons, low boiling hydrocarbons, and the like, illustrative of which are tricholoromonofluoromethane, dichloromethane, trichloromethane, dichloromonofluoromethane, chloromethane, 1,1-dichloro-1-fluoroethane, 1,1,2-trichloro-1,2,2-trifluoroethane, 1,1,1,2-tetrafluoroethane (HFC 134a), 1,1,1,3,3,-petafluorobutane (365mfc), 1,1,1,3,3-pentafluoropropane (245fa); pentane, (n-, iso- and cylopentane) hexane, and the like.

The process for preparing microcellular polyurethanes involves delivering a predetermined quantity of the liquid mixture into a heated, closable mold. The isocyanato-containing stream is usually held at a temperature of from about 25° C. to about 90° C., the polyol-containing stream is usually held at a temperature of from about 30° C. to about 100° C., and the mold is kept at a temperature between about 30° C. to about 100° C. The mold is closed and the reaction components begin to react and generate heat. The heat causes the blowing agent to volatilize and the reacting mixture foams. Simultaneously, the reaction mixture gels and then cures into a closed cell foam that has an integral skin formed at the mold surface. The skin forms because the mold surface is cooler than the bulk reaction mixture. In a related process also envisioned in this invention, the mixing is accomplished by a static mixer placed at the heated closed-mold entrance in what is known as the “reaction injection molding” or RIM process.

In the process for preparing the microcellular polyurethane elastomers, it is usually desirable to use small amounts, about 0.001% to about 2.0% by weight based on the total reaction mixture, of a surfactant or emulsifying agent. Illustrative of the surfactants are polysiloxane-polyoxyalkylene block copolymer, polyoxyalkylene adducts of alcohols in which ethylene oxide is added to the alcohol, dimethyl silicone oil, polyethoxylated vegetable oils, and the like.

Optionally, various modifying agents that are known to those skilled in the art of polyurethane manufacture can be added to the polyurethane elastomer-forming formulations. Illustrative of these agents are carbon black, titanium dioxide, zinc oxide, various clays, various pigments, fillers, dyes and other colorants, plasticizers that do not contain any reactive end groups, chopped glass, carbon, graphite, and specialty fibers, mold releases, stearic acid, and the like.

The polyurethanes of this invention are used as shoe soles, gaskets, solid tires, automobile fascia and bumpers, toys, furniture, appliance and business machine housings, animal feeding troughs, printing rolls, toys, adhesives, coatings, sealants, fibers, powders useful as powder coatings, optical lenses, protective shields, wheels, as well as numerous other commercial uses.

Certain of the following examples are provided to further illustrate this invention. It is to be understood that all manipulations were carried out under a nitrogen atmosphere unless otherwise stated. Also, all examples were carried out at ambient temperature unless otherwise stated.

The ingredients and tests used in the examples are as described in the following glossary:

### Glossary

Catalyst 1—Dibutyltin dilaurate commercially available from Air Products Company as Dabco™ T-12.

Chain Extender 1—1,4-butanediol.

Isocyanate 1—A 50/50 mixture of 1,3-bis(isocyanatomethyl)cyclohexane and 1,4-bis(isocyanatomethyl)cyclohexane isomers.

Isocyanate 2—1,4-bis(isocyanatomethyl)cyclohexane isomer; 50/50 cis/trans ratio purchased from Aldrich Chemical Company.

Isocyanate 3—4,4′-methylene bis(cyclohexyl isocyanate) or 4,4′dicyclohexylmethane diisocyanate, commercially available from Bayer AG as Desmodur™ W. This isocyanate is also known as H₁₂MDI.

Polyol 1—A poly(oxytetramethylene) glycol with a number-average molecular weight of approximately 2,000.

Polyol 2—A polycaprolactone glycol with a number-average molecular weight of approximately 1000 available by The Dow Chemical Company as Tone 0240.

Compression Set, Method B; ASTM D 395, Test Methods for Rubber Property—Compression Set. The higher the value, the more prone the elastomer to lasting deformation when tested under a load.

Glass Transition Temperature, Tg—Differential Scanning Calorimetry Resilience—the temperature at which the elastomer turns from a glassy material into a rubbery material.

Resilience, Bashore Rebound; ASTM D 430, Test Methods for Rubber Deterioration, Dynamic Fatigue. The higher the value the more resilient the elastomer.

Shore Hardness; ASTM D 2240, Test Method for Rubber Property—Durometer Hardness. The higher the value, the harder the elastomer.

Softening Point—Thermomechanical analysis. The temperature at which the elastomer begins to soften.

Stress-Strain Properties—Tensile Strength at Break, Ultimate Elongation, 100% and 300% Modulus (Stress at 100% and 300% Elongation); ASTM D 412, Test Methods for Rubber Properties in Tension.

Tear Resistance; Graves Die C, ASTM D 624, Test Methods for Rubber Property—Tear Resistance. The higher the value, the more tear resistant the elastomer.

### EXAMPLE 1

A mixture of 3-cyano-1-cyclohexanecarboxaldehyde and 4-cyano-1-cyclohexanecarboxaldehyde product (cis and trans forms for each isomer) were prepared from 3-cyclohexene-1-carbonitrile as per the procedure of U.S. Pat. No. 6,252,121, the disclosure of which is incorporated herein by reference.

To an aqueous ammonia solution (28 weight percent, 31 milliliters) in an ice bath was added dropwise 4.25 grams of the aldehyde mixture and resulting mixture stirred for 4 hours at room temperature. A white solid was filtered off, dried in vacuum for 2 hours, dissolved in methanol (30 milliliters) and hydrogenated at 950 psi and 100° C. in the presence of nickel on silica/alumina (0.2 grams) and ammonia (6 grams) for 3 hours. The products included 1,3- and 1,4-bis(isocyanatomethyl)cyclohexane. The product yield was 93% by gas chromatography. Vacuum distillation of the crude diamine (4 grams) gave 2.57 grams of the pure material boiling at 73° C./1 mmHg, ¹³C NMR (CDCl₃, ppm): 20.28; 25.15; 25.95; 28.93; 29.84; 30.30; 32.04; 34.48; 35.74; 38.61; 40.53; 41.02; 45.45; 45.91; 48.30; 48.47. The diamine was converted to the 1,3-,1,4-bis(isocyanatomethyl)cyclohexane via phosgenation. (W. Siefken, Ann. Chem., 562, 75 (1949)).

### EXAMPLES 2 AND 3 AND COMPARATIVE EXAMPLES A

The thermoplastic polyurethane compositions of Examples 2 and 3 and the thermoplastic polyurethane of Comparative Example A using the same polyol and chain extender were prepared in the following manner. The polyol, chain extender and catalyst were combined and preheated to 100° C., weighed into a 250 milliliter plastic cup, mixed with a high speed mixer, and degassed under vacuum for a few minutes. The polyfunctional isocyanate was then added to the mixture of polyol, chain extender and catalyst and the combination of all ingredients was mixed for an additional minute. The mixture was placed in an oven at 100° C. until the onset of gelling was observed. Gelling was apparent after about two to three minutes. The reaction mixture was then removed from the oven and poured into a Teflon-coated mold that had been preheated to 115° C. The mold was placed in a Carver press, and then compression molded at 20,000 psi for one hour. The resulting thermoplastic polyurethane sheet was removed from the mold and post cured in a 105° C. oven for 16 hours. The sheet was then removed from the oven, cooled to room temperature and stored under ambient conditions until it was tested for physical properties. The amounts of ingredients, curing conditions, and physical properties are given in Table A below.

The isocyanate index was the same for Examples 2 and 3 and Comparative Example A, which resulted in a hard segment concentration of 34% in the Example 2 and 3 elastomers and 33% in the Comparative Example A elastomer. The elastomer of Example 3, having the highest concentration of trans 1,4-isomer, exhibited the highest Shore A hardness.

TABLE A

| | | | Comparative |
|---|---|---|---|
| | Example 2 | Example 3 | Example A |
| | Isocyanate 1 | Isocyanate 2 | Isocyanate 3 |
| Formulation (pbw) | | | |
| Polyol 1 | 100.00 | 100.00 | 100.00 |
| Chain Extender 1 | 13.05 | 13.06 | 8.68 |
| Isocyanate | 39.42 | 39.46 | 39.88 |
| Catalyst 1, wt. % | 0.072 | 0.071 | 0.013 |
| Isocyanate Index | 1.05 | 1.05 | 1.05 |
| Hard Segment | 34 | 34 | 33 |
| Conc., % | | | |
| Properties | | | |
| Hardness, Shore A | 61 | 82 | 73 |
| Tensile Strength, psi | 3108 | 5031 | 3005 |
| Elongation at Break, | 1280 | 893 | 1260 |
| % | | | |
| Stress at 100% | 220 | 594 | 269 |
| Strain, psi | | | |
| Stress at 300% | 286 | 1029 | 409 |
| Strain, psi | | | |
| Tear resistance, | 278 | 402 | 423 |
| lbs/in | | | |
| Resilience | 46 | 54 | 40 |
| Compression Set at | 12 | 17 | 24 |
| 70° C., % | | | |
| Tg (via DSC), ° C. | −71 | −69 | −65 |
| Softening | 193 | 191 | 146 |
| Temperature, ° C. | | | |

The elastomer of Example 2 can be further characterized as being strong and tough (combination of strength and elongation), tear resistant, and resilient with very good compression set, good low temperature resistance (Tg), and a high melting point. The elastomer of Example 4 and Comparative Example A are equivalent in most properties, but the Example 3 is more resilient, less prone to set under compression, and has a higher melting temperature than the Comparative Example A.

The elastomers of Examples 2, 3 and Comparative Example A were all colorless and transparent

### EXAMPLES 4-7 AND COMPARATIVE EXAMPLES B-D

The thermoplastic polyurethane compositions of Examples 4-7 (from Isocyanate 1) and the thermoplastic polyurethane compositions of Comparative Examples B-D (from Isocyanate 3) were prepared as described above for Examples 2-3, using Polyol 2 and Chain Extender 1. The hard segment concentration (wt. %) was varied from 22 to 50 for examples 4 to 7 and from 30 to 50 for Comparative Examples B to D, to allow meaningful comparisons to be made of the physical properties of the polyurethane elastomers. The polyurethane elastomers of the invention (Examples 4-7) had a good balance of mechanical properties as was observed for Comparative Examples B-D. The elastomers of the invention had superior performance properties (higher hardness, higher resistance to tear, better rebound properties, and lower compression set) across the range of hard segment concentrations versus Comparative Examples B-D.

TABLE B

| | | | | Exam- |
|---|---|---|---|---|
| Designation | Example 4 | Example 5 | Example 6 | ple 7 |
| Formulation | | | | |
| (pbw) | | | | |
| Polyol 2 | 100.00 | 100.00 | 100.00 | 100.00 |
| Chain Extender 1 | 5.69 | 10.27 | 17.73 | 28.13 |
| Isocyanate 1 | 22.47 | 32.51 | 48.92 | 71.79 |
| Catalyst 1 (wt. %, | 0.033 | 0.050 | 0.050 | 0.050 |
| of Polyol 2 & | | | | |
| 1,4-BD) | | | | |
| Isocyanate Index | 102 | 102 | 102 | 102 |
| % Hard Segment | 22 | 30 | 40 | 50 |
| Properties | | | | |
| Hardness, Shore A | 65 | 73 | 86 | 92 |
| Tensile strength, psi | 4745 | 6235 | 6472 | 5576 |
| 100% Modulus, psi | 248 | 407 | 458 | 602 |
| 300% Modulus, psi | 377 | 671 | 968 | 1266 |
| Elongation at break, | 1038 | 939 | 896 | 679 |
| % | | | | |
| Young's modulus, | 666 | 746 | 726 | 931 |
| psi | | | | |
| Tear Resistance, | 287 | 416 | 483.9 | 530.6 |
| Graves, die C, pli | | | | |
| Bashore rebound, % | 43 | 42 | 35 | 27 |
| Compression set, % | 53 | 37 | 41 | 58 |
| (method B) | | | | |
| Appearance | transparent | transparent | transparent | clear |

TABLE C

| | Comparative | Comparative | Comparative |
|---|---|---|---|
| Designation | Example B | Example C | Example D |
| Formulation (pbw) | | | |
| Polyol 2 | 100.00 | 100.00 | 100.00 |
| Chain Extender 1 | 7.34 | 13.29 | 21.60 |
| Isocyanate 3 | 35.50 | 53.35 | 78.20 |
| Catalyst 1 (wt. % | 0.033 | 0.033 | 0.033 |
| of Polyol 2 & 1,4-BD) | | 102 | 102 |
| Isocyanate Index | 102 | | |
| % Hard Segment | 30 | 40 | 50 |
| Properties | | | |
| Hardness, Shore A | 60 | 83 | 84 |
| Tensile strength, psi | 6966 | 8306 | 7872 |
| 100% Modulus, psi | 350 | 504 | 1063 |
| 300% Modulus, psi | 638 | 1018 | 2297 |
| Elongation at break, % | 1040 | 870 | 638 |
| Young's modulus, psi | 1727 | 2396 | 2519 |
| Tear resistance, | 327 | 399 | 497 |
| Graves, die C, pli | | | |
| Bashore rebound, % | 35 | 26 | 25 |
| Compression set, % | 72 | 55 | 72 |
| (method B) | | | |
| Appearance | Hazy | Transparent | Clear |

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A polyurethane comprising the reaction product of a cycloaliphatic diisocyanate, a polyol and a chain extender, wherein said cycloaliphatic diisocyanate comprises (i) trans-1,4-bis(isocyanatomethyl)cyclohexane or (ii) an isomeric mixture of two or more of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, with the proviso said isomeric mixture comprises at least about 5 weight percent of said trans-1,4-bis(isocyanatomethyl)cyclohexane.

2. An isocyanato-terminated prepolymer prepared by reacting a polyol with a bis(isocyanatomethyl)cyclohexane compound.

3. A polyurethane prepolymer composition of claim 2 wherein the bis(isocyanatomethyl)cyclohexane comprising comprises (i) trans-1,4-bis(isocyanatomethyl)cyclohexane or (ii) an isomeric mixture of two or more of cis-1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, with the proviso said isomeric mixture comprises at least about 5 weight percent of said trans-1,4-bis(isocyanatomethyl)cyclohexane.

4. A composition comprising an isomeric mixture of cis1,3-bis(isocyanatomethyl)cyclohexane, trans-1,3-bis(isocyanatomethyl)cyclohexane, cis-1,4-bis(isocyanatomethyl)cyclohexane and trans-1,4-bis(isocyanatomethyl)cyclohexane, wherein said isomeric mixture comprises at least about 5 weight percent of said trans-1,4-bis(isocyanatomethyl)cyclohexane.

5. A composition comprising an isomeric mixture of cis-1,3-cyclohexane-bis(aminomethyl), trans-1,3-cyclohexane-bis(aminomethyl), cis-1,4-cyclohexane-bis(aminomethyl) and trans-1,4-cyclohexane-bis(aminomethyl), wherein said isomeric mixture comprises at least about 5 weight percent of said trans-1,4-cyclohexanebis(aminomethyl).

6. The polyurethane of claim 1 wherein said polyol is selected from a poly(tetramethylene oxide) diol, a polylactone polyol, a poly(epsilon caprolactone) polyol, a polyester polyol, an alkylene oxide polyol, a poly(propylene oxide) polyol, poly(butadiene) polyol and an ethylene oxide capped poly(propylene oxide) polyol.

7. The polyurethane of claim 1 wherein the chain extender comprises an aliphatic diol having from 2 to about 8 carbon atoms.

8. The polyurethane of claim 7 wherein said aliphatic diol is 1,4-butanediol.

9. The polyurethane of claim 1 wherein the chain extender comprises a diamine.

10. The polyurethane of claim 9 wherein the chain extender is an aliphatic diamine.

11. The polyurethane prepolymer composition of claim 3 wherein 0.1 to 20 percent by weight of at least one different polyfunctional isocyanate is present in the composition.

12. The polyurethane prepolymer composition of claim 11 wherein the different polyfunctional isocyanate comprises methyldiphenyl diisocyanate, isophorone diisocyanate or toluene diisocyanate, HDI and H12MDI (hydrogenated MDI).

13. The polyurethane of claim 1 which is in the form of a shaped, molded, cast, spun article, reaction injection molding, blow molding, injection molding or extrusion molding.
